(19) United States
(12) Patent Application Publication
(10) Pub. No.: US 2020/0331088 A1
(43) Pub. Date: Oct. 22, 2020

(54) REPAIRING METHODS FOR HYDRAULIC-END VALVE CAGE CAVITY AND PLUNGER-END SEAL HOLE

(71) Applicant: Shanghai Qinghe Machinery CO., LTD., Shanghai (CN)

(72) Inventors: He Wang, Shanghai (CN); Yang Li, Shanghai (CN); Pinhui Fan, Shanghai (CN); Zhengyu Zhu, Shanghai (CN); Haikun Feng, Shanghai (CN)

(21) Appl. No.: 16/464,457

(22) PCT Filed: Sep. 30, 2018
(86) PCT No.: PCT/CN2018/109028

§ 371 Date: May 28, 2019

(30) Foreign Application Priority Data
Aug. 10, 2018 (CN) 201810908256.0

(51) Int. Cl. B23K 9/167; B23K 9/235

(52) U.S. Cl. CPC B23K 9/167; B23P 6/00; B23K 9/235

(57) ABSTRACT

The present invention provides a repairing method for a hydraulic-end valve cage cavity. First, a to-be-repaired hydraulic-end valve cage cavity is mechanically processed to reserve a unilateral repair size of the cavity; shot blasting and cleaning are performed on the cavity; basic repairing is performed on the cavity to form a backing welding layer, and welding and cladding repairing are performed on the backing welding layer for n layers, to form n repair-welding layers; and finally machine finishing is performed on the cavity having undergone welding repair. The repairing method is also applicable to repairing of a plunger-end seal hole. The repairing method provided in the present invention is simple and is easy to be controlled, and a repaired hydraulic-end valve cage and plunger-end seal hole can be used in on-site fracturing construction in a condition of 50 MPa to 100 MPa for 200 h. By repairing the hydraulic-end valve cage and the plunger-end seal hole, equipment costs for oil fracturing can be significantly reduced.

This application claims priority to Chinese Patent Application No. 201810908256.0, filed with the Chinese Patent Office on Aug. 10, 2018 and entitled “REPAIRING METHODS FOR HYDRAULIC-END VALVE CAGE CAVITY AND PLUNGER-END SEAL HOLE”, which is incorporated herein by reference in its entirety.

### TECHNICAL FIELD

The present invention relates to the welding repair field, and in particular, to repairing methods for a hydraulic-end valve cage cavity and a plunger-end seal hole.

### BACKGROUND

A hydraulic-end valve cage is a core key component applied to the field of oil drilling and exploitation devices, and is mainly a dedicated device that is used for fracturing the formation at a depth of 3000 m to 7000 m to form ground cracks and injecting various propping agents through high pressure to form an oil reservoir. The hydraulic-end valve cage can withstand high pressure and has a large discharge capacity and corrosion resistance.

A plunger pump hydraulic-end is mainly an apparatus that performs self-sucking of low-pressure fluid through a suction end, converts the low-pressure fluid to high-pressure fluid, and discharges the high-pressure fluid from a discharge end. The hydraulic-end valve cage is a veritable vulnerable part in the fracturing equipment field, and the service life of the hydraulic-end valve cage varies according to different fracturing conditions of an oil field. In conventional low-pressure hydraulic fracturing process conditions (low acid, low pressure, small discharge capacity, intermittent operation), it can be used for 300 hours to 500 hours; in conditions of high pressure, high acid, large discharge capacity, and intermittent operation, it can be used for 200 hours to 240 hours; and in unconventional exploitation conditions (high acid, high pressure, large discharge capacity, and continuous operation) of shale gas, oil, dense oil gas, coal bed gas, and the like, the service life of the hydraulic-end valve cage is only 160 hours to 220 hours. A total cost of a hydraulic end requires RMB several hundred thousand, even though engineers perform material improvement and structure optimization, use a new surface treatment technology, and the like to prolong its service life, but a received effect is that the service life is increased by only 20% to 30%, and costs are increased a lot. Comprehensively, there is no much improvement in costs and efficiency. Therefore, reducing manufacturing costs of the hydraulic-end valve cage and prolonging the service life of the hydraulic end valve cage are an important link to reduce oil exploitation costs in China.

The hydraulic-end valve cage is a necessary vulnerable part in a fracturing truck, and performance of the hydraulic-end valve cage is critical to oil exploitation and fracturing operation. Because a fracturing pump works in a harsh environment for a long time, and its valve cage structure is complex, although very-high-cost high-quality steel and a fine processing technology are used, the fracturing pump is quickly scrapped due to corrosion and cracking under an action of ultra-high pressure, a large discharge capacity, and a high sand ratio. Currently, at a highest manufacturing level in the world, in conventional fracturing working conditions, a working time of the fracturing pump is only approximately 200 hours.

A large number of failure analysis reports for hydraulic-end valve cages and plunger ends that have been cracked and have failed on site show that a main failure mode is seal failure and cracking resulting from pitting corrosion. Samples of a failed valve cage part and a plunger end body show that there is no much loss in a mechanical property of a material thereof compared with a mechanical property of the material in an original state, and the property is attenuated by approximately 10% on average, and in this case, cracking of the material itself does not mean that a limit of its service life is reached. Therefore, before the valve cage and the plunger end fail, repairing the valve cage and the plunger end can enable them to be reused, to prolong the service life of the valve cage and the plunger end to a greatest extent, so as to reduce fracturing and exploitation costs. However, there is no effective repairing method currently.

### SUMMARY

To overcome the foregoing disadvantages in the prior art, the present invention provides repairing methods for a hydraulic-end valve cage cavity and a plunger-end seal hole. The repairing methods provided in the present invention can effectively repair a hydraulic-end valve cage cavity and a plunger-end seal hole, prolong the service life of a hydraulic-end valve cage and a plunger end, and reduce fracturing and exploitation costs.

To resolve the above problem, the present invention provides a repairing method for a hydraulic-end valve cage cavity, including the following steps:

(1) performing mechanical preprocessing on a cavity of a to-be-repaired hydraulic-end valve cage until a reserved unilateral repair size of the cavity is 4 mm to 5 mm, where the to-be-repaired hydraulic-end valve cage is a hydraulic-end valve cage that is cracked but does not fail;

(2) performing shot blasting and cleaning successively on a surface of the mechanically processed cavity;

(3) performing basic welding and cladding repairing on the cleaned cavity, to form a transition layer on the surface of the cavity, where a thickness of the transition layer is greater than or equal to 1 mm, and a welding material for basic welding is a soft welding material;

(4) performing welding and cladding repairing for n layers successively on a surface of the transition layer, to form n repair-welding layers, where n≥2, a total effective surfacing thickness of the n repair-welding layers and the transition layer is greater than or equal to 5 mm, and a mechanical property and corrosion resistance of a welding material for welding in step (4) is higher than that of a base metal of the to-be-repaired hydraulic-end valve cage; and

(5) performing machine finishing on the hydraulic-end valve cage cavity having undergone welding repair in step (4).

Preferably, welding in step (3) and step (4) is non-melting tungsten inert-gas shielded welding.

Preferably, welding methods in step (3) and step (4) is annular autorotation multi-pass welding;

automatic impulse welding frequency for welding is independently 2.5 HZ to 5.0 HZ, and a pulse ratio is independently 40% to 60%;

a main current for welding is independently 150 A to 210 A;

a heater current for welding is independently 30 A to 70 A;

a heater voltage for welding is 14 V;

electrical polarity of welding is direct current reverse polarity;

a specification of the welding material for welding is independently φ1 mm to φ3 mm;

protective gas for welding is argon gas, and a flow rate of argon gas is independently 16 L/min to 19 L/min;

a diameter size of a nozzle for welding is independently φ8 mm to φ10 mm;

a wire feed rate for welding is independently 1500 mm/min to 2000 mm/min;

a welding speed is independently 100 mm/min to 500 mm/min;

interlayer temperature for welding is independently lower than 200° C.; and

heat input power for welding is independently 0.4 KJ/mm to 0.6 KJ/mm

Preferably, the welding materials for welding in step (3) and step (4) each are independently an iron based material, a nickel-based material, or stainless steel.

Preferably, when the base metal of the hydraulic-end valve cage is carbon steel, and the welding material for welding in step (4) is ER49, ER50, or ERCoCR-A.

Preferably, when the base metal of the hydraulic-end valve cage is alloy steel, the welding material for welding in step (4) is EDZCr-C-15, ER50, or ERCoCR-A.

Preferably, when the base metal of the hydraulic-end valve cage is stainless steel, and the welding material for welding in step (4) is A022Mo, E317L-16, ER49, ER50, or ERCoCR-A.

Preferably, step (3) further includes performing weld preheating on the hydraulic-end valve cage before basics welding and cladding repairing, where preheating temperature is 160° C. to 200° C.; and a preheating time is 2 h to 3 h.

Preferably, temperature of the hydraulic-end valve cage in the wilding processes in step (3) and step (4) is not lower than 150° C.

Preferably, step (4) further includes heat insulation treatment after performing welding and cladding repairing for n layers, where insulation temperature is 160° C. to 200° C.; and a heat insulation time is 4 h to 5 h.

Preferably, surface roughness of the cavity having undergone shot blasting in step (2) is 1 μm to 100 μm.

The present invention provides a repairing method for a plunger-end seal hole, where according to the above-described method, a to-be-repaired hydraulic-end valve cage cavity is replaced by a plunger-end seal hole, to repair the plunger-end seal hole.

The present invention provides a repairing method for a hydraulic-end valve cage cavity. First, a to-be-repaired hydraulic-end valve cage cavity is mechanically processed to reserve a unilateral repair size of the cavity; shot blasting and cleaning are performed on the cavity; basic repairing is performed on the cavity to form a backing welding layer, welding and cladding repairing are performed on the backing welding layer for n layers, to form n repair-welding layers; and finally machine finishing is performed on the cavity having undergone welding repair. The repairing method provided in the present invention is simple and is easy to be controlled, and a repaired hydraulic-end valve cage can continue to be used in fracturing construction in a condition of 50 MPa to 100 MPa for approximately 200 h. By repairing the hydraulic-end valve cage, equipment costs for oil fracturing can be significantly reduced.

The present invention further provides a repairing method for a plunger-end seal hole. A repairing process is the same as the repairing process of a hydraulic-end valve cage cavity. A repaired plunger-end can continue to be used in fracturing construction in a condition of 50 MPa to 100 MPa for approximately 200 h.

### DETAILED DESCRIPTION

The present invention is further described below with reference to the accompanying drawings and embodiments.

The present invention provides a repairing method for a hydraulic-end valve cage cavity, including the following steps:

(1) Perform mechanical preprocessing on a cavity of a to-be-repaired hydraulic-end valve cage to make a reserved unilateral repair size of the cavity be 4 mm to 5 mm, where the to-be-repaired hydraulic-end valve cage is a hydraulic-end valve cage that is cracked but does not fail.

(2) Perform shot blasting and cleaning successively on a surface of the machine-processed cavity.

(3) Perform basic welding and cladding repairing on the cleaned cavity, to form a transition layer on the surface of the cavity, where a thickness of the transition layer is greater than or equal to 1 mm.

(4) Perform welding and cladding repairing for n layers successively on a surface of the transition layer, to form n repair-welding layers, where n≥2, a total effective surfacing thickness of the n repair-welding layers and the transition layer is greater than or equal to 5 mm, and a mechanical property and corrosion resistance of a welding material for welding in step (4) is higher than that of a welding material for welding in step (3).

(5) Perform machine finishing on the hydraulic-end valve cage cavity having undergone welding repair in step (4).

In the present invention, mechanical preprocessing is performed on the to-be-repaired hydraulic-end valve cage cavity to make the reserved unilateral repair size of the cavity be 4 mm to 5 mm. In the present invention, the to-be-repaired hydraulic-end valve cage is a hydraulic-end valve cage that is cracked but does not fail, and is preferably a hydraulic-end valve box having been used for 200 h. In the present invention, mechanical preprocessing is performed on a size of the valve cage cavity to ensure that the reserved unilateral repair size is 4 mm to 5 mm, thereby ensuring a thickness of a repair layer. The present invention imposes no special requirement on a specific mechanical preprocessing method, as long as a processing size required in the present invention can be reached, specifically including turning, milling, grinding, and the like.

In the present invention, after preprocessing is completed, shot blasting and cleaning are successively performed on a surface of the mechanically processed cavity. In the present invention, surface roughness of the cavity having undergone shot blasting is preferably 1 μm to 100 μm, more preferably 1 μm to 20 μm, further preferably 6 μm to 6.5 μm, and most preferably 6.3 μm. The present invention imposes no special requirement on a specific shot blasting method, as long as required surface roughness can be obtained by using shot blasting well known to a person skilled in the art. In the present invention, surface roughness of the cavity is increased through shot blasting, so that there is sufficient adhesion between a welding material of the transition layer and the surface of the valve cage cavity.

In the present invention, cleaning is preferably cleaning with gasoline. In the present invention, impurities and dirt such as oil stains and rust on the surface of the cavity are removed by cleaning, so as to prevent impurities from affecting the adhesion performance of the welding material and a base material.

In the present invention, after cleaning is completed, basic welding and cladding repairing are performed on the cleaned cavity, to form a transition layer on the surface of the cavity. In the present invention, basic welding is preferably performed on the hydraulic-end valve cage after preheating processing is performed. Preheating processing temperature is preferably 160° C. to 200° C. and more preferably 180° C.; and a preheating time is preferably 2 h to 3 h and more preferably 2 h. In the present invention, a heat treatment furnace is preferably used to preheat the hydraulic-end valve cage, and in the present invention, a good temperature condition is provided for subsequent welding through preheating.

In the present invention, after preheating is completed, the valve cage is taken out of the furnace, and basic welding and cladding repairing are performed on the cavity. In the present invention, welding is preferably non-melting tungsten inert-gas shielded welding (TIG welding). Automatic impulse welding frequency for welding is preferably 2.5 HZ to 5.0 HZ and more preferably 3 HZ to 4 HZ. A pulse ratio is preferably 40% to 60% and more preferably 50%. A main current for welding is preferably 150 A to 210 A and more preferably 180 A to 200 A. A heater current for welding is preferably 30 A to 70 A and more preferably 40 A to 60 A. A heater voltage for welding is preferably 14 V. Electrical polarity of welding is preferably direct current reverse polarity (DCEN). A specification of the welding material for welding is preferably φ1 mm to φ3 mm and more preferably φ2 mm Protective gas for welding is preferably argon gas, a mixing ratio of argon gas is preferably 99.999%, and a flow rate of argon gas is preferably 16 L/min to 19 L/min and more preferably 18 L/min. A diameter size of a nozzle for welding is preferably φ8 to φ10 mm and more preferably φ10 mm. A wire feed rate for welding is preferably 1500 mm/min to 2000 mm/min and more preferably 1600 mm/min to 1800 mm/min. A welding speed is preferably 100 mm/min to 500 mm/min and more preferably 200 mm/min to 400 mm/min. Interlayer temperature for welding is preferably lower than 200° C. and more preferably 100° C. to 150° C. Heat input power for welding is preferably 0.4 KJ/mm to 0.6 KJ/mm and more preferably 0.5 KJ/mm.

In the present invention, a welding material for basic welding is preferably a soft welding material, and is preferably an iron-based material, a nickel-based material, or stainless steel. In the present invention, the welding material is selected according to a material of the to-be-repaired hydraulic-end valve cage. In a specific embodiment of the present invention, the welding material for basic welding is preferably stainless steel ER309LMo. In a welding process, a welding gun preferably automatically rotates at 45° to perform welding from inside to outside at a constant speed, to ensure that no wires are broken or welding is not stopped during welding, thereby ensuring the performance of a welded material.

In the present invention, a thickness of the transition layer is preferably greater than or equal to 1 mm and more preferably 1 mm to 2 mm. In the present invention, a transition layer is formed on the surface of the cavity through basic welding, to allow the base material adhered to the material of the repair-welding layer.

In the present invention, after basic welding is completed, welding and cladding repairing for n layers is successively performed on a surface of the transition layer, to form n repair-welding layers. In the present invention, n≥2, and n is preferably 2 to 5. A total effective surfacing thickness of the n repair-welding layers and the transition layer is greater than or equal to 5 mm, and is preferably 5 mm to 6 mm. The present invention imposes no special requirement on a single-layer thickness of the n repair-welding layers, as long as the total effective surfacing thickness of the n repair-welding layers and the transition layer can meet the foregoing requirement.

In the present invention, a welding material for welding in step (4) is preferably an iron-based material, a nickel-based material, or stainless steel, and a mechanical property and corrosion resistance of the welding material for welding in step (4) is higher than that of a base metal of the hydraulic-end valve cage. In a specific embodiment of the present invention, when the base metal of the hydraulic-end valve cage is carbon steel, the welding material for welding in step (4) is preferably ER49, ER50, or ERCoCR-A; when the base metal of the hydraulic-end valve cage is alloy steel, the welding material for welding in step (4) is preferably EDZCr-C-15, ER50, or ERCoCR-A; and when the base metal of the hydraulic-end valve cage is stainless steel, the welding material for welding in step (4) is preferably A022Mo, E317L-16, ER49, ER50, or ERCoCR-A. In the present invention, a high-performance welding material is used on the surface of the transition layer for multilayer cladding repairing, so that a cracked position of the hydraulic-end valve cage can be repaired well.

In a specific embodiment of the present invention, preferably, welding and cladding repairing from a first layer to an n^{th} layer is performed successively on the surface of the transition layer, and welding and cladding repair for a next layer are preferably welding along a welding trough of a current welding layer, to ensure fusion performance between welding layers. In the present invention, welding conditions of a process of welding and cladding repairing for n layers are the same as those of the foregoing solution, and details are not repeated herein.

In the present invention, temperature of the hydraulic-end valve cage in the wilding processes in step (3) and step (4) is not lower than 150° C. and more preferably 160° C. to 180° C. In the present invention, the temperature of the hydraulic-end valve cage is ensured to ensure that welding and cladding repairing is smoothly performed.

In the present invention, after welding and cladding repairing for n layers is completed, the hydraulic-end valve cage having undergone welding repair is placed in the furnace for heat insulation 4 h, to eliminate welding stress. Heat insulation temperature is preferably 160° C. to 200° C. In a specific embodiment of the present invention, heat insulation is preferably performed at welding temperature without additional heating or cooling.

In the present invention, after heat insulation is completed, the hydraulic-end valve cage is preferably taken out of the furnace and air cooled to 50° C.

In the present invention, after air cooling, a geometric size of the repaired hydraulic-end valve cage cavity is preferably detected, to ensure that there is enough machining allowance in a subsequent machine finishing process. In the present invention, a machining allowance herein is preferably determined according to a specific method used in the subsequent machine finishing process, and if machine finishing is performed subsequently through a lathe operation, finishing allowance after welding repair is preferably 2 mm. In the present invention, whether there is enough machining allowance is determined through geometric size check of the cavity, and if the machining allowance is not enough, cladding repairing described in the foregoing solution preferably continues to be performed, until there is enough finishing allowance.

In the present invention, after geometric size check, nondestructive testing is preferably performed on the repaired hydraulic-end valve cage. Nondestructive testing preferably includes UT ultrasonic testing, PT penetration testing, and RT visual testing. UT ultrasonic testing is used to detect whether there is a defect (a crack, included slag, a pore, non-fusion) inside the valve cage; the PT penetration testing is used to detect whether there is a defect (a crack, included slag, and a pore) on a surface; and RT visual testing is used to detect whether a macroscopic surface is qualified (a pore, a crack, undercut, spatter, weld beading, and a weld size). In the present invention, if a nondestructive testing result is unqualified, a repair layer is preferably removed, and welding repair is performed again according to the foregoing solution.

In the present invention, after nondestructive testing is completed, mechanical property testing is preferably performed on the repaired hydraulic-end valve cage, to ensure that a mechanical property of a fusion part meets a requirement. In the present invention, mechanical property testing is preferably used for testing a mechanical property of a base material at 1.5 mm below a fusion line according to the ASTM A370 standard. In the present invention, if the mechanical property is unqualified, the repair layer is preferably removed, and welding repair is performed again according to the foregoing solution.

In the present invention, after nondestructive testing is completed, metallographic inspection is preferably performed on the hydraulic-end valve cage to macroscopically verify that a welding cross section has no fusion lines, included slag, pores, cracks, and other linear defects. The present invention imposes no special requirement on a specific metallographic inspection method, as long as a metallographic inspection method well known to a person skilled in the art is used. In the present invention, if a metallographic inspection result is unqualified, the repair layer is preferably removed, and welding repair is performed again according to the foregoing solution.

In the present invention, after metallographic inspection is completed, machine finishing is performed on the repaired hydraulic-end valve cage to obtain a required finishing size. In the present invention, machine finishing is preferably turning, milling, and grinding.

In the present invention, after machine finishing, surface PT penetration testing and full-scale final inspection are preferably performed on the finished hydraulic-end valve cage successively. In the present invention, surface PT penetration testing is used to check whether a welding cross section has included slag, pores, cracks, and other linear defects, and full-scale final inspection is used to finally determine whether the size of the repaired hydraulic-end valve cage meets a requirement.

In the present invention, if a full-scale final inspection result is qualified, clearing and assembly are preferably performed on the hydraulic-end valve cage, and then pressure testing is performed. Pressure testing is preferably hydrapress measurement, and is specifically as follows: An inner part of the valve cage is pressurized to 1.5 times of rated pressure; and pressure of the valve cage is kept for 15 minutes without leakage. Then, strip inspection is performed to detect whether a welding repair part is deformed; and if deformation occurs, the repair layer is preferably removed, and welding repair is performed again according to the foregoing solution.

The present invention further provides a repairing method for a plunger-end seal hole, a to-be-repaired hydraulic-end valve cage cavity is replaced by a plunger-end seal hole, to repair the plunger-end seal hole according to the method in the foregoing solution. Specific steps include mechanical preprocessing, basic welding, welding and cladding repairing for n layers, property testing, and machine finishing of the plunger-end seal hole. An operation method of each step is the same as that in the foregoing solution, and details are not repeated herein.

In the present invention, if a seal failure or cracking problem occurs again after a repaired hydraulic-end valve cage and plunger-end seal hole are used for a period of time, the method in the present invention can be used again for repairing.

With reference to embodiments, the following describes in detail the repairing methods for a hydraulic-end valve cage cavity and a plunger-end seal hole provided in the present invention, but the repairing methods are not construed as a limitation on the protection scope of the present invention.

### Embodiment 1

Step 1: Select a hydraulic-end valve cage having been used for 200 h, and perform mechanical preprocessing on a cavity of the hydraulic-end valve cage until a reserved unilateral repair size of the cavity is 4 mm to 5 mm.

Step 2: Perform shot blasting on a surface of the processed cavity to ensure that surface roughness is 6.3, so as to ensure that there is enough adhesion between a backing stainless steel material and a surface of an inner hole of the valve cage.

Step 3: Clean the valve cage cavity by using gasoline to remove impurities and dirt from the surface of the valve cage cavity.

Step 3: Perform weld preheating to adjust temperature of a heat treatment furnace to 180° C.

Step 4: Place the to-be-repaired valve cage in the furnace for heat insulation for 2 hours.

Step 5: Perform checking and confirmation as follows before welding is performed.

Device TIG welding (Tungsten Inert Gas Welding) non-melting tungsten inert-gas shielded welding

Welding method GTAW-Pulsed-Hot wire; autorotation multi-pass welding (annular)

Automatic impulse welding frequency 2.5 HZ to 5.0 HZ; pulse ratio 50%

Main current 150 A

Heater current 30 A

Heater voltage 14 V

Electrical polarity DCEN

Welding material specification φ1.2 mm

Protective gas Ar; mixing ratio 99.999%; flow rate 16 L/min

Nozzle diameter size φ10 mm

Wire feed rate 1,500 mm/min

Welding speed 300 mm/min

Interlayer temperature <200° C.

Heat input power 0.5 KJ/mm

Step 6: Take the valve cage out of a furnace to ensure that welding repair is performed according to a process when temperature of the valve cage is not lower than 150° C., repair a first layer by using a backing stainless steel welding material ER309LMo, and control a welding and cladding speed to ensure that a welding layer thickness is 2 mm, where a welding gun automatically rotates at 45° to perform welding from inside to outside at a constant speed, and it is not allowed that wires are broken or welding is stopped during welding.

Step 7: Repair a second layer by using a stainless steel welding material ERCCoCr-A whose performance higher than that of a base metal as a main welding material to perform cladding repairing, where welding is performed along a welding trough of a transition layer to ensure fusion performance between welding layers.

Step 8: Repair a third layer by still using a stainless steel welding material ERCCoCr-A as a main welding material to perform cladding repairing, where welding is performed along a lowest trough to ensure fusion performance between welding layers, so as to ensure an effective surfacing thickness of three repair welding layers is larger than 5 mm.

Step 9: Place the valve cage into the furnace for heat insulation for 4 hours to eliminate welding stress.

Step 10: Take out the valve cage out of the furnace, and perform air cooling to 50° C.

Step 11: Repair an inner-hole geometry size and perform check to ensure machining allowance after welding.

Step 12: Perform nondestructive testing on the repaired hydraulic-end valve cage, including a UT ultrasonic testing, PT penetration testing, and RT visual testing, where a nondestructive testing result is qualified.

Step 13: Test a mechanical property of a base material at 1.5 mm below a fusion line according to the ASTM A370 standard, where a testing result shows that the mechanical property is qualified.

Step 14: Perform metallographic inspection on the repaired hydraulic-end valve cage to show that a welding cross section has no fusion lines, included slag, pores, cracks, and other linear defects.

Step 15: Perform machine finishing on the repaired hydraulic-end valve cage to obtain a finally finishing size.

Step 16: Perform surface PT penetration testing on the finished hydraulic-end valve cage, where a result shows that the surface has no included slag, pores, cracks, and other linear defects.

Step 17: Perform full-scale final inspection.

Step 18: Perform cleaning and assembly.

Step 19: Perform pressure testing to check seal fit performance

Step 20: Perform strip inspection to show that there is no deformation at a welding repair part.

The repaired hydraulic-end valve cage continues to be used in on-site fracturing construction in a condition of 50 MPa to 100 MPa, and service time can reach 200 h.

### Embodiment 2

Other steps are the same as those in Embodiment 1, and only the welding parameters in step 5 are changed. The welding parameters are as follows:

Device TIG welding (Tungsten Inert Gas Welding) non-melting tungsten inert-gas shielded welding

Welding method GTAW-Pulsed-Hot wire autorotation multi-pass welding (annular)

Automatic impulse welding frequency 2.5 HZ to 5.0 HZ; pulse ratio 50%

Main current 180 A

Heater current 60 A

Heater voltage 14 V

Electrical polarity DCEN

Welding material specification φ1.2 mm

Protective gas Ar; mixing ratio 99.999%; flow rate 19 L/min

Nozzle diameter size φ10 mm

Wire feed rate 2,000 mm/min

Welding speed 500 mm/min

Interlayer temperature <200° C.

Heat input power 0.5 KJ/mm

After welding is completed, geometric size check, nondestructive testing, mechanical property testing, and metallographic inspection are successively performed on the repaired hydraulic-end valve cage, and test results are all qualified.

Machine finishing is performed on the repaired hydraulic-end valve cage to obtain a finally finishing size; surface PT penetration testing is performed on the finished hydraulic-end valve cage, and a result shows that the surface has no included slag, pores, cracks, and other linear defects.

Full-scale final inspection, cleaning, and assembly are successively performed on the finished hydraulic-end valve cage; then pressure testing is performed, and strip inspection is performed to show that there is no deformation at a welding repair part.

The repaired hydraulic-end valve cage continues to be used in on-site fracturing construction in a condition of 50 MPa to 100 MPa, and service time can reach 200 h.

### Embodiment 3

Other steps are the same as those in Embodiment 1, and only the welding parameters in step 5 are changed. The welding parameters are as follows:

Device TIG welding (Tungsten Inert Gas Welding) non-melting tungsten inert-gas shielded welding

Welding method GTAW-Pulsed-Hot wire autorotation multi-pass welding (annular)

Automatic impulse welding frequency 2.5 HZ to 5.0 HZ; pulse ratio 50%

Main current 210 A

Heater current 70 A

Heater voltage 14 V

Electrical polarity DCEN

Welding material specification φ1.2 mm

Protective gas Ar; mixing ratio 99.999%; flow rate 18 L/min

Nozzle diameter size φ10 mm

Wire feed rate 1800 mm/min

Welding speed 200 mm/min

Interlayer temperature <200° C.

Heat input power 0.5 KJ/mm

After welding is completed, geometric size check, nondestructive testing, mechanical property testing, and metallographic inspection are successively performed on the repaired hydraulic-end valve cage, and test results are all qualified.

Machine finishing is performed on the repaired hydraulic-end valve cage to obtain a finally finishing size; surface PT penetration testing is performed on the finished hydraulic-end valve cage, and a result shows that the surface has no included slag, pores, cracks, and other linear defects.

Full-scale final inspection, cleaning, and assembly are successively performed on the finished hydraulic-end valve cage; then pressure testing is performed, and strip inspection is performed to show that there is no deformation at a welding repair part.

The repaired hydraulic-end valve cage continues to be used in on-site fracturing construction in a condition of 50 MPa to 100 MPa, and service time can reach 200 h.

It can be learned from the foregoing embodiments that the repairing method provided in the present invention has simple steps, easy operation, and good repairing effect.

The above description of the embodiment is only for helping to understand the method of the present invention and its core idea. It should be noted that, several improvements and modifications may be made by persons of ordinary skill in the art without departing from the principle of the present invention, and these improvements and modifications should also be considered within the protection scope of the present invention. Various modifications to these embodiments are readily apparent to persons skilled in the art, and the generic principles defined herein may be practiced in other embodiments without departing from the spirit or scope of the invention. Thus, the present invention is not limited to the embodiments shown herein but falls within the widest scope consistent with the principles and novel features disclosed herein.

1. A repairing method for a hydraulic-end valve cage cavity, comprising the following steps:
(1) performing mechanical preprocessing on a cavity of a to-be-repaired hydraulic-end valve cage until a reserved unilateral repair size of the cavity is 4 mm to 5 mm, wherein the to-be-repaired hydraulic-end valve cage is a hydraulic-end valve cage that is cracked but does not fail;
(2) performing shot blasting and cleaning successively on a surface of the mechanically processed cavity;
(3) performing basic welding and cladding repairing on the cleaned cavity, to form a transition layer on the surface of the cavity, wherein a thickness of the transition layer is greater than or equal to 1 mm, and a welding material for basic welding is a soft welding material;
(4) performing welding and cladding repairing for n layers successively on a surface of the transition layer, to form n repair-welding layers, wherein n≥2, a total effective surfacing thickness of the n repair-welding layers and the transition layer is greater than or equal to 5 mm, and a mechanical property and corrosion resistance of a welding material for welding in step (4) is higher than that of a base metal of the to-be-repaired hydraulic-end valve cage; and
(5) performing machine finishing on the hydraulic-end valve cage cavity having undergone welding repair in step (4).

2. The repairing method according to claim 1, wherein welding in step (3) and step (4) is non-melting tungsten inert-gas shielded welding.

3. The repairing method according to claim 1, wherein welding methods in step (3) and step (4) is annular autorotation multi-pass welding;
automatic impulse welding frequency for welding is independently 2.5 HZ to 5.0 HZ, and a pulse ratio is independently 40% to 60%;
a main current for welding is independently 150 A to 210 A;
a heater current for welding is independently 30 A to 70 A;
a heater voltage for welding is 14 V;
electrical polarity of welding is direct current reverse polarity;
a specification of the welding material for welding is independently φ1 mm to φ3 mm;
protective gas for welding is argon gas, and a flow rate of argon gas is independently 16 L/min to 19 L/min;
a diameter size of a nozzle for welding is independently φ8 mm to φ10 mm;
a wire feed rate for welding is independently 1500 mm/min to 2000 mm/min;
a welding speed is independently 100 mm/min to 500 mm/min;
interlayer temperature for welding is independently lower than 200° C.; and
heat input power for welding is independently 0.4 KJ/mm to 0.6 KJ/mm.

4. The repairing method according to claim 1, wherein the welding materials for welding in step (3) and step (4) each are independently an iron based material, a nickel-based material, or stainless steel.

5. The repairing method according to claim 1, wherein when the base metal of the hydraulic-end valve cage is carbon steel, and the welding material for welding in step (4) is ER49, ER50, or ERCoCR-A.

6. The repairing method according to claim 1, wherein when the base metal of the hydraulic-end valve cage is alloy steel, the welding material for welding in step (4) is EDZCr-C-15, ER50, or ERCoCR-A.

7. The repairing method according to claim 1, wherein when the base metal of the hydraulic-end valve cage is stainless steel, and the welding material for welding in step (4) is A022Mo, E317L-16, ER49, ER50, or ERCoCR-A.

8. The repairing method according to claim 1, wherein step (3) further comprises performing weld preheating on the hydraulic-end valve cage before basics welding and cladding repairing, wherein preheating temperature is 160° C. to 200° C.; and a preheating time is 2 h to 3 h.

9. The repairing method according to claim 1, wherein temperature of the hydraulic-end valve cage in the wilding processes in step (3) and step (4) is not lower than 150° C.

10. The repairing method according to claim 1, wherein step (4) further comprises heat insulation treatment after performing welding and cladding repairing for n layers, wherein insulation temperature is 160° C. to 200° C.; and a heat insulation time is 4 h to 5 h.

11. The repairing method according to claim 1, wherein surface roughness of the cavity having undergone shot blasting in step (2) is 1 μm to 100 μm.

12. A repairing method for a plunger-end seal hole, wherein according to the method according to claim 1, a to-be-repaired hydraulic-end valve cage cavity is replaced by a plunger-end seal hole, to repair the plunger-end seal hole.

13. The repairing method according to claim 2, wherein welding methods in step (3) and step (4) is annular autorotation multi-pass welding;
automatic impulse welding frequency for welding is independently 2.5 HZ to 5.0 HZ, and a pulse ratio is independently 40% to 60%;
a main current for welding is independently 150 A to 210 A;
a heater current for welding is independently 30 A to 70 A;
a heater voltage for welding is 14 V;
electrical polarity of welding is direct current reverse polarity;
a specification of the welding material for welding is independently φ1 mm to φ3 mm;
protective gas for welding is argon gas, and a flow rate of argon gas is independently 16 L/min to 19 L/min;
a diameter size of a nozzle for welding is independently φ8 mm to φ10 mm;
a wire feed rate for welding is independently 1500 mm/min to 2000 mm/min;
a welding speed is independently 100 mm/min to 500 mm/min;
interlayer temperature for welding is independently lower than 200° C.; and
heat input power for welding is independently 0.4 KJ/mm to 0.6 KJ/mm.

14. The repairing method according to claim 2, wherein the welding materials for welding in step (3) and step (4) each are independently an iron based material, a nickel-based material, or stainless steel.

15. A repairing method for a plunger-end seal hole, wherein according to the method according to claim 2, a to-be-repaired hydraulic-end valve cage cavity is replaced by a plunger-end seal hole, to repair the plunger-end seal hole.

16. A repairing method for a plunger-end seal hole, wherein according to the method according to claim 3, a to-be-repaired hydraulic-end valve cage cavity is replaced by a plunger-end seal hole, to repair the plunger-end seal hole.

17. A repairing method for a plunger-end seal hole, wherein according to the method according to claim 4, a to-be-repaired hydraulic-end valve cage cavity is replaced by a plunger-end seal hole, to repair the plunger-end seal hole.

18. A repairing method for a plunger-end seal hole, wherein according to the method according to claim 5, a to-be-repaired hydraulic-end valve cage cavity is replaced by a plunger-end seal hole, to repair the plunger-end seal hole.

19. A repairing method for a plunger-end seal hole, wherein according to the method according to claim 6, a to-be-repaired hydraulic-end valve cage cavity is replaced by a plunger-end seal hole, to repair the plunger-end seal hole.

20. A repairing method for a plunger-end seal hole, wherein according to the method according to claim 7, a to-be-repaired hydraulic-end valve cage cavity is replaced by a plunger-end seal hole, to repair the plunger-end seal hole.
